(19) United States
(12) Patent Application Publication
(10) Pub. No.: US 2014/0041773 A1
(43) Pub. Date: Feb. 13, 2014

(54) MOTORCYCLE PROTECTION AND SECURITY DEVICE

(71) Applicant: Support Enterprises, Inc., Jamestown, NY (US)

(72) Inventor: Harold Roberts, Jamestown, NY (US)

(73) Assignee: Support Enterprises, Inc., Jamestown, NY (US)

(21) Appl. No.: 13/961,578

(22) Filed: Aug. 7, 2013

Related U.S. Application Data
(60) Provisional application No. 61/680,468, filed on Aug. 7, 2012.

(51) Int. Cl. B62J 19/00

(52) U.S. Cl. CPC B62J 19/00
USPC 150/167

(57) ABSTRACT

Embodiments of the present invention relate to a protective cover/bag (hereinafter “protective device”) for preserving and securing motorized vehicles such motorcycles, ATVs, or the like. In an embodiment, the protective device may be designed to completely enclose most motorcycles. The bottom may be constructed with a durable material such as 1000 denier, which can be capable of withstanding multiple years of use. The protective device may be made with water repellant material. A fastener for enclosing the vehicle within the protective device may be industrial strength and/or military tested. Two vent flaps may be provided to allow air flow around the vehicle. Still yet, a protective flap may be provided to protect against water entering through the fastener.

### TECHNICAL FIELD

The present invention relates generally to motorcycle protection and security. Specifically, the present invention generally relates to a lockable cover to protect and secure motorized vehicles such as motorcycles, all-terrain vehicles (ATVs), or the like.

### BACKGROUND OF THE INVENTION

Motorcycles, ATVs, or the like have become popular forms of transportation and/or recreation. Riders often utilize such forms of transportation for short range and/or long range trips. Along with regular upkeep and maintenance, the protection and/or security of such vehicles from weather exposure and/or unauthorized third parties may be highly important in preserving the life of the vehicles. This can especially be the case if a vehicle is located in an extreme climate and/or high theft risk environment.

Existing approaches often rely on multiple different devices and/or means for preserving and/or securing such vehicles. That is, users are often currently forced to apply multiple devices to such vehicles in order to both protect and secure such vehicles. Such a requirement can be time consuming and/or frustrating. As such, existing approaches often go under-utilized.

### SUMMARY OF THE INVENTION

In general, embodiments of the present invention relate to a protective cover/bag (hereinafter “protective device”) for preserving and securing motorized vehicles such as motorcycles, ATVs, or the like. In an embodiment, the protective device may be designed to completely enclose most motorcycles. The bottom may be constructed with a durable material such as 1000 denier, which can be capable of withstanding multiple years of use. The protective device may be made with water repellant material. A fastener for enclosing the vehicle within the protective device may be industrial strength and/or military tested. Two vent flaps may be provided to allow air flow around the vehicle. Still yet, a protective flap may be provided to protect against water entering through the fastener.

A first aspect of the present invention provides a motor vehicle protective device, comprising: a body portion having a front portion for receiving a front portion of a motor vehicle, a rear portion for receiving a rear portion of a motor vehicle, and a center portion for receiving a motor vehicle with a longitudinal axis posited proximate a longitudinal axis of the center portion of the body portion, when in an opened position; a directional marker on the body portion indicating placement of the motor vehicle with respect to the body portion; and at least one fastener that fastens the body portion around the motor vehicle when in a closed position.

A second aspect of the present invention provides a motor vehicle protective device, comprising: a vehicle cover comprising: a first side flap portion, a second side flap portion, and a bottom portion; and a fastener that joins the first side flap portion and the second side flap portion when in a closed position to enclose substantially an entirely of a motor vehicle; wherein the cover is configured to receive the vehicle along a longitudinal center of the vehicle proximate a longitudinal center of the bottom portion of the cover.

A third aspect of the present invention provides method for enclosing a motor vehicle in a protective device, comprising: orienting a protective device in an open configuration on a surface, placing a vehicle near a center of the protective device, aligning the vehicle with at least one indicia of vehicle placement, lifting at least a side portion of the protective device over the vehicle, and enclosing the vehicle within the protective device using a fastener. Optionally, the method can further comprise locking the protective device.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a side view of a vehicle cover or protective device in an open position according to an embodiment of the present invention.

FIG. 2 depicts an angled view of a vehicle cover or protective device in an open position according to an embodiment of the present invention.

FIG. 3 depicts a front view of a vehicle cover or protective device in an open position according to an embodiment of the present invention.

FIG. 4 depicts a side view of a vehicle cover or protective device being applied according to an embodiment of the present invention.

FIG. 5 depicts a side view of a vehicle cover or protective device in a closed position according to an embodiment of the present invention.

FIG. 6 depicts an angled view of a vehicle cover or protective device in a closed position according to an embodiment of the present invention.

FIG. 7 depicts a side-rear view of a vehicle cover or protective device in a closed position according to an embodiment of the present invention

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Illustrative embodiments now will be described more fully herein with reference to the accompanying drawings, in which embodiments are shown. This disclosure may, however, be embodied in many different forms and should not be construed as limited to the embodiments set forth herein. Rather, these embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As indicated above, embodiments of the present invention relate to a protective cover/bag (hereinafter “protective device”) for preserving and securing motorized vehicles such motorcycles, ATVs or the like. In an embodiment, the protective device may be designed to completely enclose most motorcycles. The bottom may be constructed with a durable material such as 1000 denier, which can be capable of withstanding multiple years of use. The protective device may be made with water repellant material. A fastener for enclosing the vehicle within the protective device may be industrial strength and/or military tested. Two vent flaps may be provided to allow air flow around the vehicle. Still yet, a protective flap may be provided to protect against water entering through the fastener. It is understood that although an illustrative embodiment of the present invention will described the protection of a motorcycle, similar concepts can be applied to other types of vehicles hereunder. For example, similar teachings could be applied to ATVs, bicycles, mopeds, golf carts, etc.

Regardless, the protective device/enclosure is designed to protect and secure an entire vehicle. The protective device comprises a fully enclosed bottom to deter unauthorized third parties, including but not limited to rodents and other pests, from accessing the vehicle. Furthermore, once the protective device is securely closed and locked, a third party, e.g., a criminal, will be unaware of the value of the vehicle therein, and finding the vehicle fully secured, may be deterred from attempting to steal the vehicle.

In general, the protective device may be portable and/or collapsible. For example, in an embodiment, a user can “roll up” the protective device and place the protective device in its own travel bag, which may be transported with the vehicle (e.g., stored in a luggage compartment, strapped to a seat back or sissy bar, etc.). In a motorcycle embodiment, illustrative overall dimensions (although not limited to) may comprise the following: a length of approximately 94 inches, a width of approximately 144 inches, and a diagonal of approximately 132 inches.

Moreover, the protective device offers several advantages over existing approaches for preserving and securing motorized vehicles. For example, as discussed above, the protective device may enclose an entire vehicle or motorcycle. With respect to preservation, existing approaches, such as vehicle covers, leave the bottom of a vehicle exposed, such as to unwanted third parties, such as nuisance rodents. However, the protective device described herein encloses an entirety of the motor vehicle, including via a closed bottom, preventing intrusion from rodents and other pests. Furthermore, with respect to security, existing approaches, such as anti-theft locks, often leave a vehicle visible to the eyes of criminals. The protective device not only can be locked, e.g., by securing one or more fasteners or closure mechanisms, e.g., zippers, with a padlock, but obscures a vehicle from view, making the vehicle more difficult and less desirable to steal.

The protective device furthermore offers additional protections. In an embodiment, composition of the protective device may include a water repellant material. In any case, the protective device offers protection of a vehicle from inclement weather. Furthermore, enclosing an entire vehicle in the protective device can allow the protective device to protect the vehicle against scratches and other accidental damage that may occur when a vehicle is allowed to remain stationary for a period of time. The portion of the protective device that is situated under the motor vehicle may itself be protected from the motor vehicle, particularly a motorcycle, by a reinforced area (e.g., a kickstand mat) disposed in the bottom of the protective device (or proximate the center of the protective device when the protective device is in an open position) to prevent damage, e.g., ripping, tearing, wear and/or the like. As discussed above, the protective device is furthermore portable, and may be easily taken on trips with a vehicle.

Additionally, the protective device offers ease of use. The design of the protective device can allow a single user to enclose a vehicle in the protective device in a short amount of time (e.g., less than five minutes). An embodiment of the protective device also comprises indicia to indicate the proper placement of a vehicle on the protective cover when in an open position for easier closure.

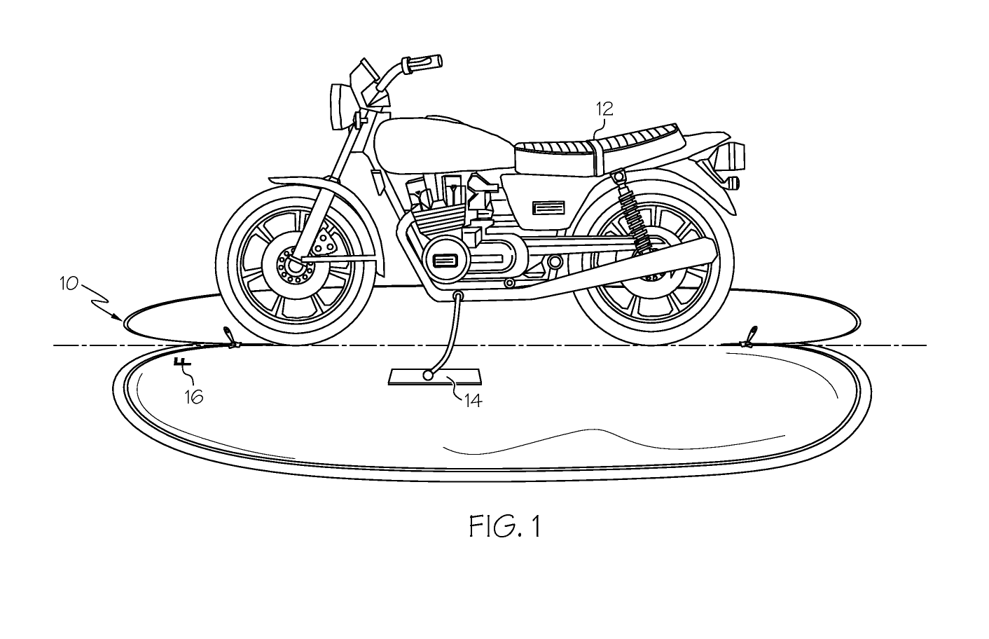

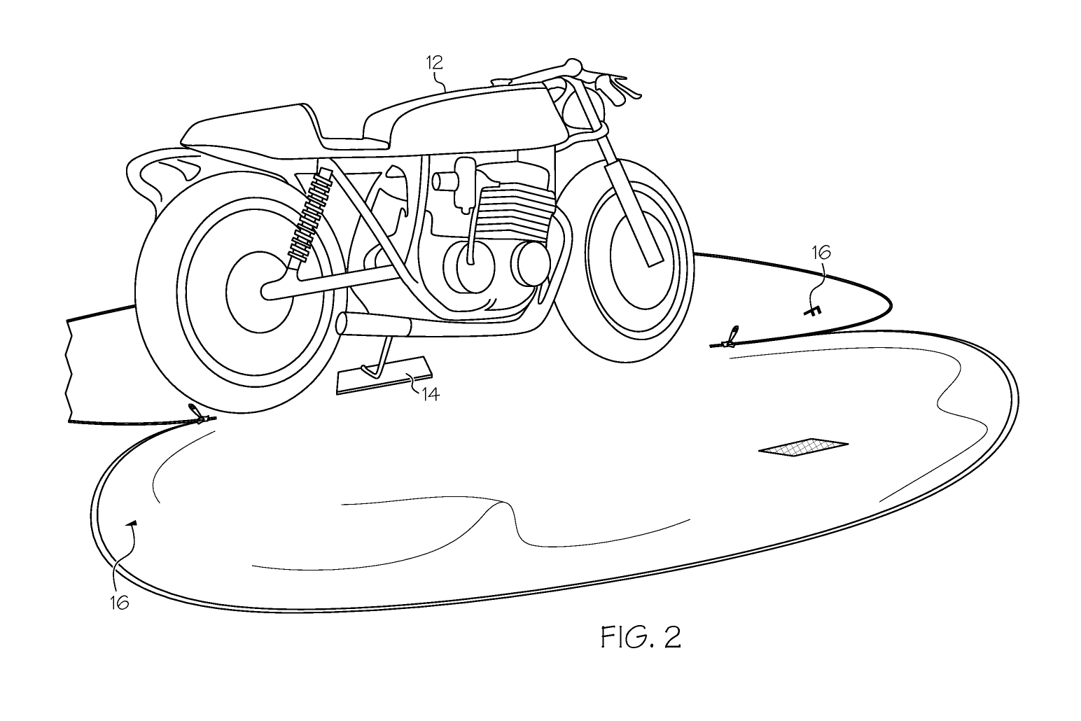

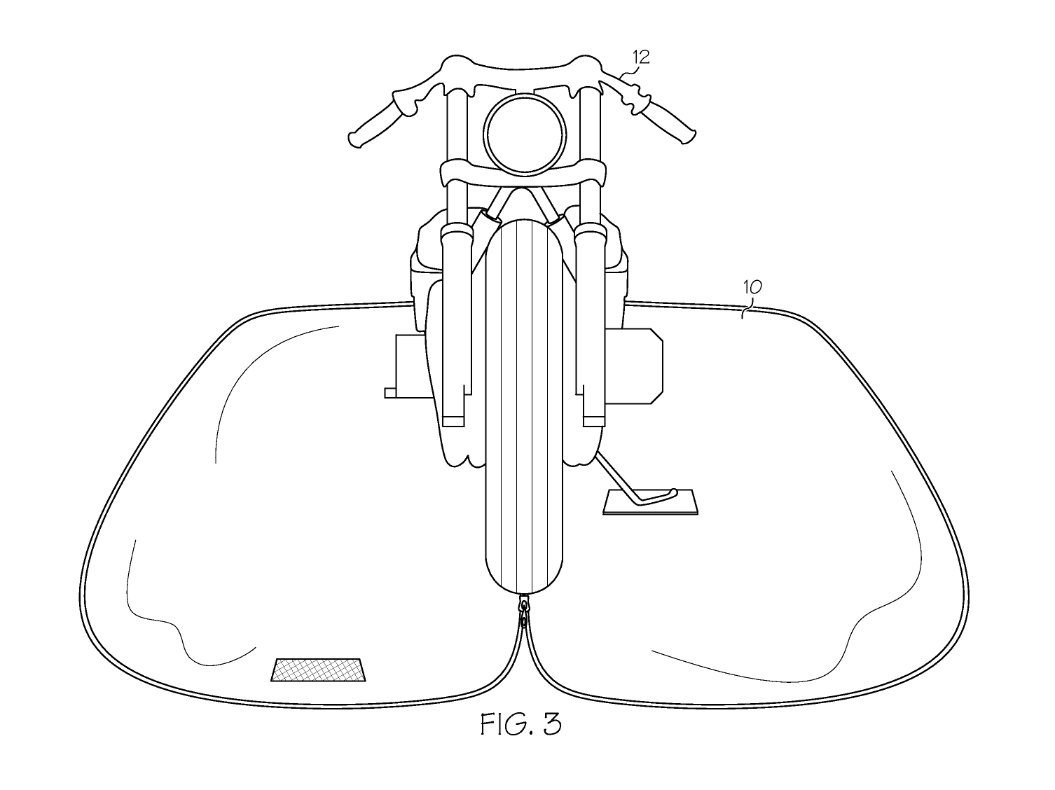

FIGS. 1-3 depicts a protective device/cover/enclosure 10 in accordance with an open position according to an embodiment of the present invention. As depicted, vehicle 12 may be positioned such that the longitudinal center of vehicle 12 is proximate to a longitudinal center of protective device 10 (as indicated via a dashed line in FIG. 1). Protective device 10 generally comprises a body portion (e.g., having a front, a rear, a left flap, a right flap, and a center portions when in an open position).

Protective device 10 may further include one or more indicia 16 (e.g., an arrow) to denote e.g., the “top” or “front of vehicle” area/portion of protective device 10. In addition, any other indicia 16 deeded necessary and/or helpful to indicate proper placement of a vehicle on protective device 10 when in an open position and/or to indicate placement of portions of protective device 10 when in a closed position are also envisioned.

Protective device 10 may further comprise a reinforced area 14 (e.g., kickstand mat/pad/patch) (e.g., comprised of leather) to denote the proper placement of vehicle 12 on protective device 10 and/or to protect a bottom portion of protective device 10 from damage, such as from a vehicle kickstand.

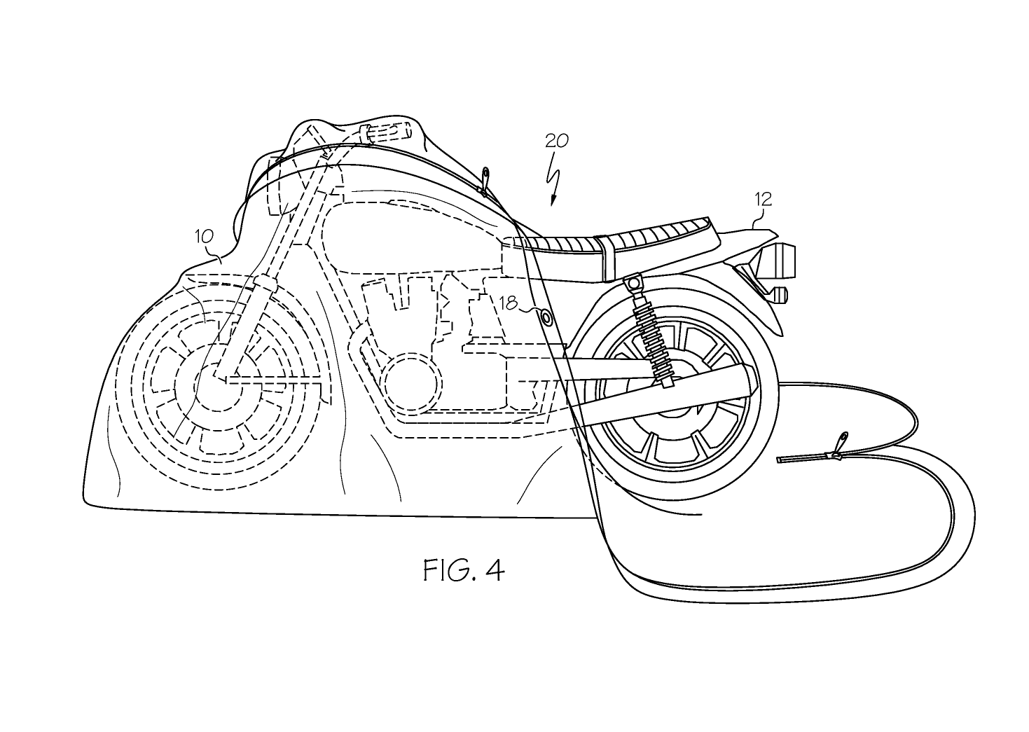

As shown, protective device 10 is laid out on a surface, and vehicle 12 is placed proximate the center thereof (as indicated via a dashed line in FIG. 1). In the example shown in FIGS. 1-3, the front of vehicle 12 (e.g., a front wheel) is positioned proximate a front portion of protective device 10, while a rear of vehicle 12 (e.g., a rear wheel) is positioned proximate a rear portion of protective device 10. A fastener 18 (FIGS. 4-7 below) in an open position, used for enclosing vehicle 12 within protective device 10, runs along the edges of left and right portions of protective device 10.

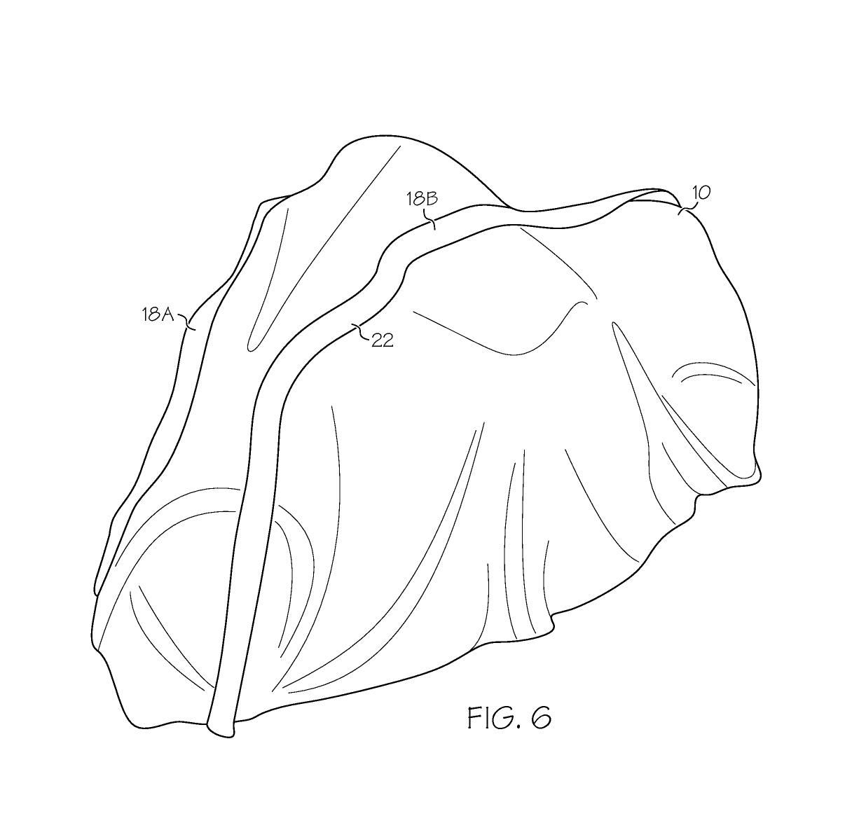

FIG. 4 depicts protective device 10 as being applied to vehicle 12. As shown in FIG. 4, in an embodiment protective device 10 is fastened around (e.g., over the top of) vehicle 12 (e.g., proximate a lateral center line 20 of vehicle 12) via one or more fasteners 18. As illustrated, in an embodiment, fastener 18 includes a zipper, the teeth of which are located on a left and right portion of protective device 10 and configured to come together e.g., proximate lateral center line 20 over the top of vehicle 12. Although fastener 18 is shown in FIG. 4 as including a zipper, other closure mechanism embodiments are envisioned within the scope of the invention (including, but not limited to hook and loop, button, latch, tie, hinge, spring, elastic, interleaving, and/or the like). In an embodiment, one or more fasteners 18 for closing protective device 10 may be located elsewhere than the lateral center of protective device 10; for example, one or more fasteners 18 may be located and configured to run approximately perpendicular to center line 20 over the top of vehicle 12, or to run approximately parallel to center line 20 such as fasteners 18A and 18B in FIG. 6 discussed below.

Furthermore, in various embodiments, protective device 10 may be fastened from both extreme ends of fastener 18 (e.g., with two or more zipper tabs on a single track) so that various components of fastener 18 meet in an approximate middle of the fastening area, although in the case of a zipper, the tabs of the zipper could be brought together anywhere along the zipper track. In other embodiments, protective device 10 may be fastened from one extreme ends to another of fastener 18 (e.g., with one zipper tab on one track). In any case, one or more fasteners 18 may be locked, e.g., by padlocking zipper tabs to one another or to an attachment on protective device 10, although other locking embodiments are also envisioned. In an embodiment, protective device 10 can be secured by applying a single locking device to a single point of fastener 18.

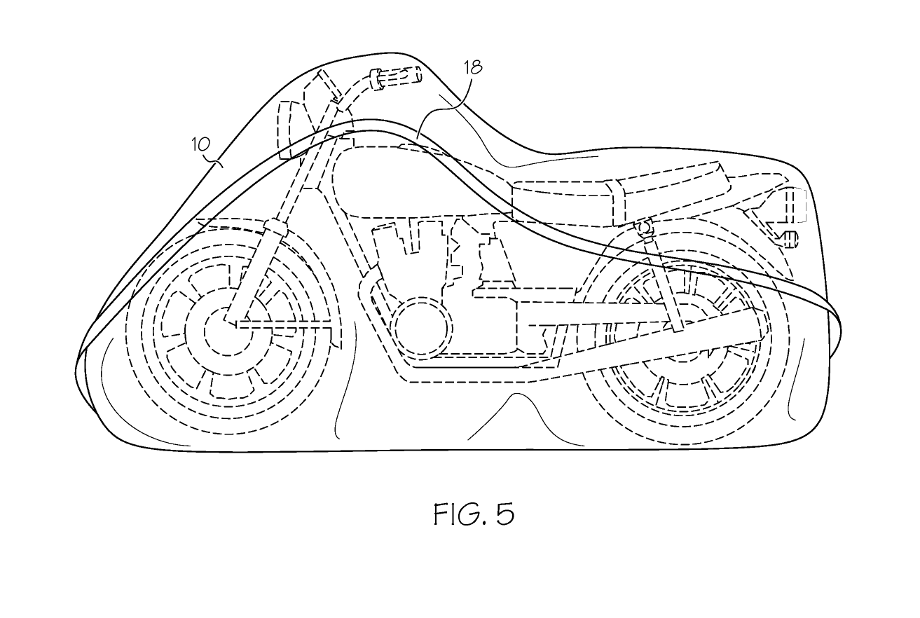

FIGS. 5-7 depict protective device 10 in a closed position around vehicle 12 (FIGS. 1-4) as secured via one or more fasteners 18. In the closed position, protective device 10 fully encloses vehicle 12. When protective device 10 is fully closed via fastener(s) 18, vehicle 12 within protective device 10 is protected from harms such as weather and moisture, damage from rodents, scratches, etc., as well as secured against theft.

FIG. 6 demonstrates that multiple zippers 18A-B may be provided for making the closure. Regardless of a single zipper 18, multiple zippers 18A-B, or other fastener 18 approach, any fasteners provided are typically protected via a protective flap or covering 22 to prevent moisture from seeping through the fastener's closure. Generally, protective flap 22 extends over and covers fastener 18 when fastener 18 is in a closed position. Protective flap 22 encourages moisture such as rain, dew, or snow, to slide down and away from fastener 18, rather than enter protective device 10 through fastener 18. Furthermore, in some embodiments, protective device 10 may be coated with or comprise water repellant or resistant material.

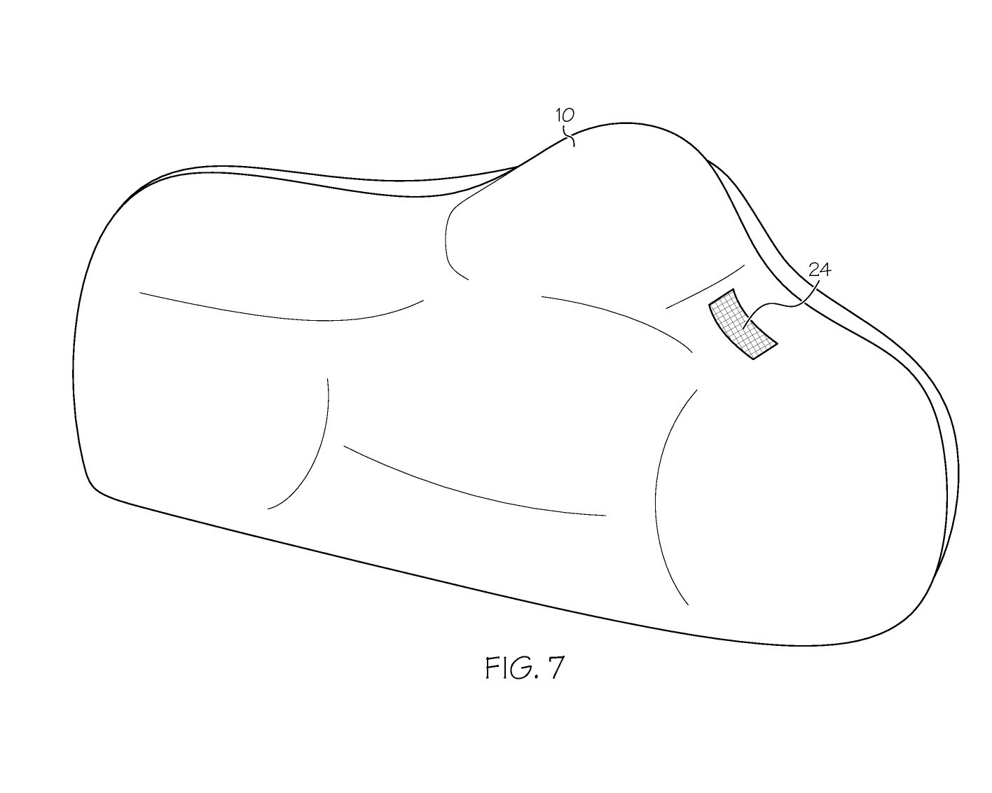

FIG. 7 depicts an embodiment of protective device 10 having one or more secure vents 24 or the like to allow for protective device 10 to breathe and release moisture (as opposed to trapping moisture and corroding vehicle 12 (FIGS. 1-4) within protective device 10. Although not shown in the figures, fasteners(s) 18 may be secured in place and/or secured closed once fastened via a locking apparatus (e.g., padlock) or the like to prevent unauthorized unfastening of protective device 10 which could result in damage to and/or removal of vehicle 12 from protective device 10. Regardless, as has been shown here, protective device 10 thus preserves and secures a vehicle contained therein.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A motor vehicle protective device, comprising:
a body portion having a front portion for receiving a front portion of a motor vehicle, a rear portion for receiving a rear portion of a motor vehicle, and a center portion for receiving a motor vehicle with a longitudinal axis posited proximate a longitudinal axis of the center portion of the body portion, when in an opened position;
a directional marker on the body portion indicating placement of the motor vehicle with respect to the body portion; and
at least one fastener that fastens the body portion around the motor vehicle when in a closed position.

2. The motor vehicle protective device of claim 1, the motor vehicle comprising a motorcycle, an all-terrain vehicle (ATV), a bicycle, a moped, or a golf cart.

3. The motor vehicle protective device of claim 1, the marker comprising at least one indicia for denoting placement of the front portion of the motor vehicle or the rear portion of the motor vehicle on the body portion.

4. The motor vehicle protective device of claim 1, the marker comprising a reinforced area in the center portion of the body portion.

5. The motor vehicle protective device of claim 1, the at least one fastener comprising at least one zipper for closing the body portion around the motor vehicle as an enclosure.

6. The motor vehicle protective device of claim 1, further comprising at least one flap covering the at least one fastener.

7. The motor vehicle protective device of claim 1, further comprising a vent for allowing moisture to exit the body portion when in a closed position.

8. A motor vehicle securing device, comprising:
a vehicle cover comprising: a first side flap portion, a second side flap portion, and a bottom portion; and
a fastener that joins the first side flap portion and the second side flap portion when in a closed position to enclose substantially an entirely of a motor vehicle;
wherein the cover is configured to receive the vehicle along a longitudinal center of the vehicle proximate a longitudinal center of the bottom portion of the cover.

9. The motor vehicle securing device of claim 8, the fastener comprising a zipper, and the bottom portion forming a center portion of the vehicle cover when the fastener is in an open position.

10. The motor vehicle securing device of claim 8, the securing device further comprising a protective covering over the fastener.

11. The motor vehicle securing device of claim 8, the fastener being configured to be locked.

12. The motor vehicle securing device of claim 8, wherein the vehicle cover is further configured to receive a front portion of the motor vehicle proximate a front portion of the vehicle cover or configured to receive a rear portion of the motor vehicle proximate a rear portion of the vehicle cover.

13. The motor vehicle securing device of claim 8, the vehicle cover being capable of receiving at least one of: a motorcycle, an all-terrain vehicle (ATV), a bicycle, a moped, and a golf cart.

14. The motor vehicle securing device of claim 8, the securing device further comprising a secure vent.

15. The motor vehicle securing device of claim 8, the securing device further comprising:
an indication of at least one of: how to place the vehicle on the vehicle cover and how to fold the cover around the vehicle, on the vehicle cover.

16. A method for enclosing a motor vehicle in a protective device: the method comprising:
orienting a protective device in an open configuration on a surface;
placing a vehicle near a center of the protective device;
aligning the vehicle with at least one indicia of vehicle placement;
lifting at least a side portion of the protective device over the vehicle; and
enclosing the vehicle within the protective device using a fastener.

17. The method for enclosing a motor vehicle in a protective device of claim 16, the method further comprising:
locking the protective device.

18. The method for enclosing a motor vehicle in a protective device of claim 16, wherein the at least one indicia of vehicle placement comprises a reinforced area proximate the center of the protective device.

19. The method for enclosing a motor vehicle in a protective device of claim 16, wherein the at least one indicia of vehicle placement comprises an indication of vehicle direction with respect to the protective device.

20. The method for enclosing a motor vehicle in a protective device of claim 16, the vehicle comprising at least one of: a motorcycle, an all-terrain vehicle (ATV), a bicycle, a moped, and a golf cart.
